(19) United States
(12) Patent Application Publication
(10) Pub. No.: US 2016/0134370 A1
(43) Pub. Date: May 12, 2016

(54) Visible Light Power-Carrying Communication System And Method

(71) Applicant: SHANGHAI RESEARCH CENTER FOR WIRELESS COMMUNICATIONS, Shanghai (CN)

(72) Inventors: Hao Huang, Shanghai (CN); Hua Qian, Shanghai (CN); Saijie Yao, Shanghai (CN); Xiumei Yang, Shanghai (CN); Kai Ying, Shanghai (CN)

(21) Appl. No.: 14/998,283

(22) Filed: Dec. 24, 2015

Related U.S. Application Data
(63) Continuation of application No. PCT/CN2014/074908, filed on Apr. 8, 2014.

(30) Foreign Application Priority Data
Jun. 26, 2013 (CN) 201310258537.3

(51) Int. Cl. H04B 10/116; H02J 7/02; H02J 5/00

(52) U.S. Cl. CPC H04B 10/116; H02J 5/005; H02J 7/025

(57) ABSTRACT

A visible light power-carrying communication system and method. The system includes a visible light power-carrying communication system of lighting facility end and a visible light power-carrying communication system of mobile user end, the latter at least includes an information transmission link, a signal collection module, a signal distribution module, an information receive link and a power collection link. The system and method combine a visible light communication system with wireless power transmission technologies, and add power link to collect power carried by a visible light signal with regard to characteristics of visible light communication system, forming a complete set of visible light power-carrying communication systems; combine advantages of visible light communication system, such as ultra-wide bandwidth, free frequency band, low power consumption of a transceiver, and solve problem that mobile terminal depends on power line by wireless power transmission technologies, realizing simultaneous wireless transmission of information and power realistically.

### CROSS-REFERENCE TO RELATED APPLICATIONS

This application is a continuation of International Application No. PCT/CN2014/074908, filed on Apr. 8, 2014, which claims priority to Chinese Patent Application No. 201310258537.3, filed on Jun. 26, 2013, all of which are hereby incorporated by reference in their entireties.

### TECHNICAL FIELD

The present invention relates to the field of wireless communication technologies and, in particular, to a visible light power-carrying communication system and a method.

### BACKGROUND

A wireless communication system enables people to get rid of restrictions from a signal line during communications by means of wireless transmission of signals. However, during a process of charging a wireless communication device, we are still subject to restrictions from a power line in space. Researches on wireless power transfer (Wireless Power Transfer, WPT) technologies are also hot issues mutually concerned by the academic field and the industrial field.

The patent with Patent Application No. CN200780053126.3 discloses a method for accomplishing wireless power transmission by means of transmitting and receiving an electromagnetic wave using a resonator. The patent with Patent Publication No. U.S. Pat. No. 8,378,523B2 accomplishes wireless power transmission and reception by means of using an electromagnetic coil. The patent with Patent Application No. CN201110264296.4 discloses an apparatus and a method for wireless power transmission based on laser resonant coupling. The patent with Patent Application No. CN200680043403.8 discloses an apparatus for power collection of a radio frequency (Radio Frequency, RF) signal. The patent with Patent Application No. CN201010250707.X discloses a sensor system capable of collecting a power source signal from the external and converting a same into power.

In the aspect where wireless transmission of information and power is performed simultaneously, the patent with Patent Publication No. US20130005252A1 and the patent with Patent Publication No. US20130069441A1 accomplish wireless power transmission and wireless signal transmitting and receiving by means of an electromagnetic coil and an antenna respectively. The patent with Patent Application No. CN200980156736.5 discloses an antenna based on electromagnetic coupling principles, which may be used for simultaneous transmission of information and power. The patent with Patent Application No. CN201210412054.X discloses a wireless power and signal cooperative transmission system based on magnetic resonance, where, a driver module may perform information interaction with a load module at the time of providing power thereto. The patent with Patent Application No. CN201020233192.8 discloses a power transmission system which is based on a resonator and loaded with a wireless control signal. The patent with Patent Publication No. US20120287985A1 uses a resonator to perform wireless transmission of power and information. The technical solution where wireless transmission of power and data is performed simultaneously by using an electromagnetic coil based on principles of electromagnetic induction is most common, which is used by the patents with Publication No. U.S. Pat. No. 7,960,867B2, No. U.S. Pat. No. 8,247,926B2, No. U.S. Pat. No. 8,315,561B2 and No. US20120299389A1.

However, the above-described techniques of simultaneous transmission of wireless information and power have the following defects:

(1) Transmission technologies based on solutions such as electromagnetic coupling, magnetic resonance, a resonator and an electromagnetic coil have short transmission distance and low power transmission efficiency, and are severely restricted by directivity, thus application thereof is greatly restricted;

(2) A solution of wireless power collection based on an RF signal has low feasibility, since a radio frequency signal received by an antenna has very small power, which is insufficient to provide a charging current, and hence practicability is low;

(3) Due to serious path loss and low power collection efficiency, an electromagnetic signal or an RF signal with large power needs to be released at a transmission end, which will incur electromagnetic pollution to environments and hazard to human bodies; what's worse, a problem such as shortage of spectrum resources results in poor implementation results for a wireless power and information transmission system based on an electromagnetic/RF signal.

Contradictions between currently rapid-growing wireless data traffic and extremely rare RF spectrum resources are standing out increasingly. The visible light communication (Visible Light Communication, VLC) technology using an ultra-wide spectrum band (400 THz˜790 THz) breaks through restrictions from the spectrum resources, which is a potential solution to provide wireless communications of large capacities. A typical visible light power-carrying communication system of a lighting facility end differs from a traditional radio frequency transceiver largely in that: a radio frequency front end is exchanged for a visible light transceiver. At a transmission end, a digital signal is firstly subject to a digital-to-analog converter (Digital-to-Analog Converter, DAC) to become an amplitude-variable analog signal, so as to control the brightness variation in a lighting emitting diode (Lighting Emitting Diode, LED), thereby loading information into a high-speed light-dark optical signal which is invisible to naked eyes. At a receive end, a photoelectric detector (Photo Diode, PD) captures and detects the brightness variation in the optical signal, and outputs a correspondingly varying electrical signal; the electrical signal is sampled by an analog-to-digital converter (Analog-to-Digital Converter, ADC) to become a digital signal, which is subsequently processed in a digital domain, such as being subject to demodulation and decision. Thus, as a specific form for wireless communication evolution, optical communication gains a lot of attention from the academic field and the industrial field due to its characteristics such as low transceiving power, immunity to complex electromagnetic interference and strong security for information transmission. For instance, the patents with Patent Publication No. U.S. Pat. No. 8,019,229B2 and No. U.S. Pat. No. 8,295,705B2 and patents with Patent Publication No. CN102246432A and No. CN102244635A all propose visible light communication system architecture and implementation methods, etc. The patent with Patent Publication No. CN200880007596.0 discloses a method for collecting power of a visible light and providing an energy source to subsequent processing, such as information demodulations, by using a solar panel.

### SUMMARY

In view of the described defects in the prior art, an objective of the present invention aims to provide a visible light power-carrying communication system and a method, which achieve, based on signal characteristics of visible light communications, wireless transmission of signal and power at a short and medium distance via a visible light signal.

In order to achieve the above objective and other related objectives, the present invention provides a visible light power-carrying communication system of a mobile user end, which at least includes:

an information transmission link, configured to transmit a visible light signal to a lighting facility end;

a signal collection module, configured to receive a visible light signal from the lighting facility end;

a signal distribution module, configured to divide, according to a certain rule, a signal output by the signal collection module into two signals, one of which is supplied to an information receive link and the other is supplied to a power collection link;

the information receive link, configured to receive information carried in the visible light signal; and

the power collection link, configured to collect power carried in the visible light signal;

where the signal collection module is connected to the signal distribution module, and the signal distribution module is then connected to the information receive link and the power collection link respectively.

According to the visible light power-carrying communication system of the mobile user end described above, where: the information transmission link at least includes a transmitted information sequence generating module, a modulating module, a digital-to-analog converting module and a visible light transmitter connected sequentially.

According to the visible light power-carrying communication system of the mobile user end described above, where: in the visible light power-carrying communication system of the mobile user end based on electrical signal distribution, the signal collection module includes a photoelectric detector which is configured to receive a visible light signal from the lighting facility end and convert the visible light signal into an electrical signal; the signal distribution module includes an electrical signal distributor which is configured to divide, according to a certain rule, the electrical signal output by the photoelectric detector into two signals, one of which is supplied to the information receive link and the other is supplied to the power collection link.

Further, according to the visible light power-carrying communication system of the mobile user end described above, where: the information receive link at least includes an analog-to-digital converting module, a demodulating module and a received information sequence deciding module connected sequentially.

Further, according to the visible light power-carrying communication system of the mobile user end described above, where: the power collection link at least includes a rectifier and a rechargeable battery, where the rechargeable battery is connected to a power supply module, and is configured to supply electric energy to all modules within the visible light power-carrying communication system.

According to the visible light power-carrying communication system of the mobile user end described above, where: in the visible light power-carrying communication system of the mobile user end based on optical signal distribution, the signal collection module includes a optical signal collector which is configured to collect a visible light signal from the lighting facility end; the signal distribution module includes a optical signal distributor which is configured to divide, according to a certain rule, an optical signal output by the optical signal collector into two signals, one of which is supplied to the information receive link and the other is supplied to the power collection link.

Further, according to the visible light power-carrying communication system of the mobile user end described above, where: the information receive link at least includes a photoelectric detector, an analog-to-digital converting module, a demodulating module and a received information sequence deciding module connected sequentially.

Further, according to the visible light power-carrying communication system of the mobile user end described above, where: the power collection link at least includes a photoelectric converter, a rectifier and a rechargeable battery connected sequentially, where the rechargeable battery is connected to a power supply module, and is configured to supply electric energy to all modules within the visible light power-carrying communication system.

Correspondingly, the present invention also provides a visible light power-carrying communication system, which includes a visible light power-carrying communication system of a lighting facility end and a visible light power-carrying communication system of a mobile user end according to any of descriptions above,

where the visible light power-carrying communication system of the lighting facility end includes an information transmission link and an information receive link, the information transmission link includes a transmitted information sequence generating module, a modulating module, a digital-to-analog converting module and a visible light transmitter connected sequentially; the information receive link includes a photoelectric detector, an analog-to-digital converting module, a demodulating module and a received information sequence deciding module connected sequentially.

In addition, the present invention also provides a communication method of a visible light power-carrying communication system according to any of the descriptions above, which includes steps of:

step 1, data uplink:

a mobile user end uses the following steps to transmit a visible light signal:

step 1-1, generating an information sequence to be transmitted;

step 1-2, modulating the information sequence;

step 1-3, performing a digital-to-analog conversion on the modulated signal to obtain an analog electrical signal;

step 1-4, driving a visible light transmitter with the analog electrical signal described in the step 1-3 to emit a visible light signal with varying light intensity;

a lighting facility end uses the following steps to receive a visible light signal:

step 1-5, detecting, by a photoelectric detector, a visible light signal, and converting the visible light signal into an electrical signal;

step 1-6, performing an analog-to-digital conversion on the electrical signal to obtain a digital signal;

step 1-7, demodulating the digital signal in a digital domain;

step 1-8, deciding information bits carried by the visible light signal;

step 2, data downlink:

the lighting facility end uses the following steps to transmit a visible light signal:

step 2-1, generating an information sequence to be transmitted;

step 2-2, modulating the information sequence;

step 2-3, performing a digital-to-analog conversion on the modulated signal to obtain an analog electrical signal;

step 2-4, driving a visible light transmitter with the analog electrical signal described in the step 2-3 to emit a visible light signal with varying light intensity;

the mobile user end uses the following steps to receive a visible light signal:

step 2-5, receiving, by a signal collection module, the visible light signal from the step 2-4;

step 2-6, dividing, by a signal distribution module, a signal output by the signal collection module into two signals according to a certain rule, one of which is distributed to an information receive link and the other is distributed to a power collection link;

step 2-7, processing, by the information receive link, the distributed signal, and finally obtaining information bits carried by the visible light signal; processing, by the power collection link, the distributed signal, and finally collecting electric energy in the visible light signal into a rechargeable battery.

As described above, the visible light power-carrying communication system and the method according to the present invention have the following beneficial effects:

(1) Combining the two important trends of technical developments of wireless communications in visible light communication and wireless power transmission;

(2) Absorbing advantages of the visible light communication system, such as low power in a transceiving stage and low loss in transmission paths;

(3) Providing power for a mobile terminal within a coverage area of visible lights, and meanwhile providing information transmission.

### BRIEF DESCRIPTION OF DRAWINGS

FIG. 1 shows a schematic structural diagram of a visible light power-carrying communication system of a lighting facility end according to the present invention;

FIG. 2 shows a schematic structural diagram of a visible light power-carrying communication system of a mobile user end based on electrical signal distribution according to the present invention; and

FIG. 3 shows a schematic structural diagram of a visible light power-carrying communication system of a mobile user end based on optical signal distribution according to the present invention.

### DESCRIPTION OF EMBODIMENTS

Implementations of the present invention will be described hereunder with reference to specific embodiments, and persons skilled in the art may easily know other advantages and effects of the present invention according to the content disclosed in the description. The present invention may also be implemented or applied according to other different embodiments, details in the description may also be modified or changed based on different viewpoints and applications without departing from the spirit of the present invention.

It should be noted that, representations provided in embodiments are merely intended for describing basic concepts of the present invention illustratively, thus the representations only show components related to the present invention, instead of being drawn according to the number, shape and dimension of components implemented actually, during actual implementations, the pattern, the number and the scale of each component may be changed optionally, and the layout pattern of the components may also be more complicated.

A core technical thought of the visible light power-carrying communication system is to collect power carried by a visible light signal by adding a power link based on architecture and characteristics of the visible light communication system, thereby achieving simultaneous transmission of information and power. The visible light power-carrying communication system proposed in the present invention includes two parts, i.e. a visible light power-carrying communication system of a lighting facility end and a visible light power-carrying communication system of a mobile user end. In order to clarify technical solutions of the present invention, the present invention will be described hereunder in details with reference to accompanying drawings.

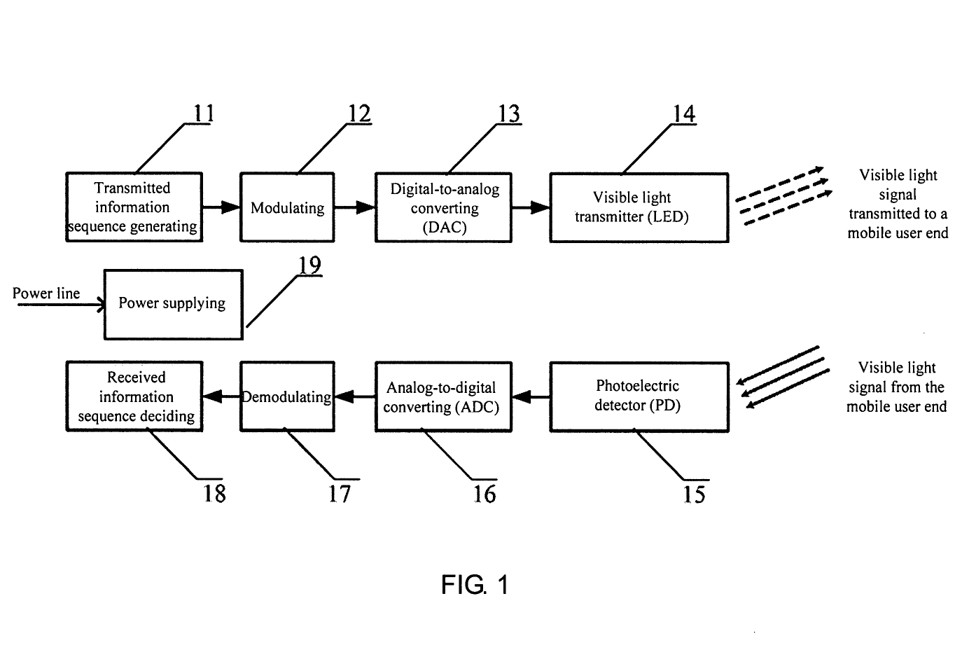

Reference may be made to FIG. 1, the visible light power-carrying communication system of the lighting facility end at least includes a transmitted information sequence generating module 11, a modulating module 12, a digital-to-analog converting module (DAC) 13, a visible light transmitter 14, a photoelectric detector (Photo Diode, PD) 15, an analog-to-digital converting module (ADC) 16, a demodulating module 17, a received information sequence deciding module 18, a power supplying module 19, etc.

A signal flow of the visible light power-carrying communication system of the lighting facility end includes an information transmission link and an information receive link. In the information transmission link, the transmitted information sequence generating module 11, the modulating module 12, the digital-to-analog converting module 13 and the visible light transmitter 14 are connected sequentially. The transmitted information sequence generating module 11 generates an information sequence to be transmitted, which is modulated by the modulating module 12, and then the digital-to-analog converting module 13 converts it into an analog electrical signal, where the analog electrical signal drives the visible light transmitter 14 to emit a visible light signal with loaded information, thereby transmitting power and information to the mobile user end.

In the information receive link, the photoelectric detector 15, the analog-to-digital converting module (ADC) 16, the demodulating module 17 and the received information sequence deciding module 18 are connected sequentially. The photoelectric detector 15 detects a visible light signal transmitted by the mobile user end, and converts it into a correspondingly varying electrical signal according to an intensity variation in the optical signal; the electrical signal is processed, such as being demodulated, by the demodulating module 17 in a digital domain subsequent to be sampled by the analog-digital converter 16; and finally the received information sequence deciding module 18 decides an information sequence.

Since a lighting facility has a relatively fixed position, quantity of electricity required is large, and thus power is provided by a power line usually. Hence, the power supplying module 19 of the visible light power-carrying communication system of the lighting facility end according to the present invention accesses to a power grid via the power line, and supplies electric energy to all modules within the apparatus.

The modulating module 12 uses a modulation mode of non-constant envelope modulation; the visible light transmitter 14 may use an LED, which may emit a visible light signal with varying brightness according to the amplitude variation of the analog electrical signal, so as to perform information propagation. The light and dark varying frequency of the visible light signal goes beyond resolution capabilities of human eyes, and thus will cause no harm to the human eyes.

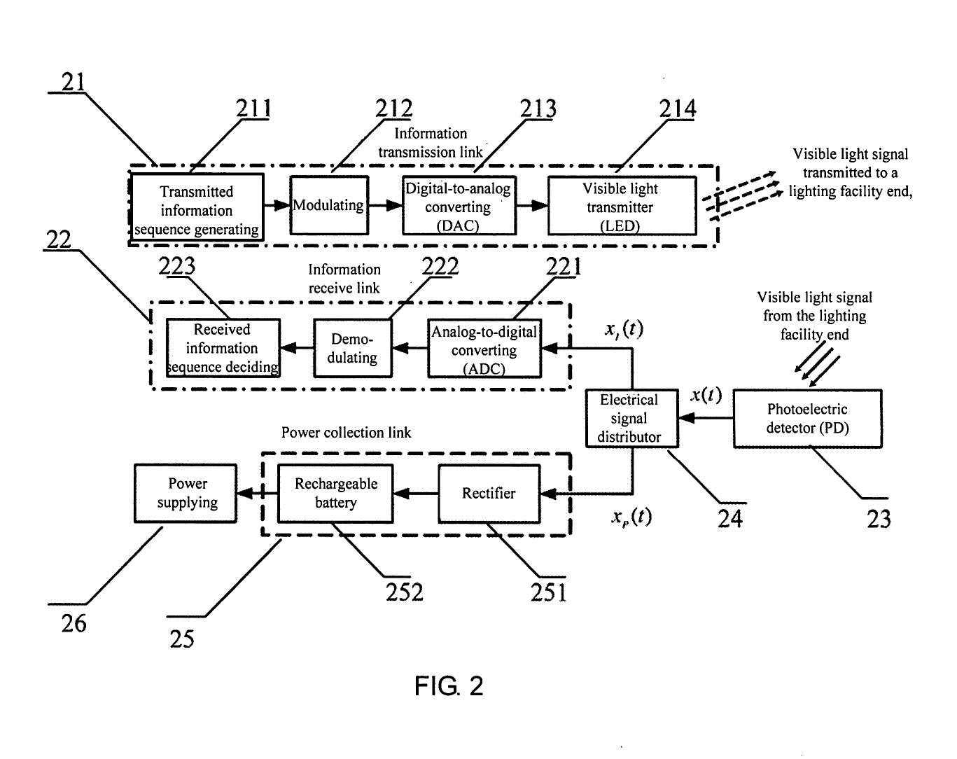

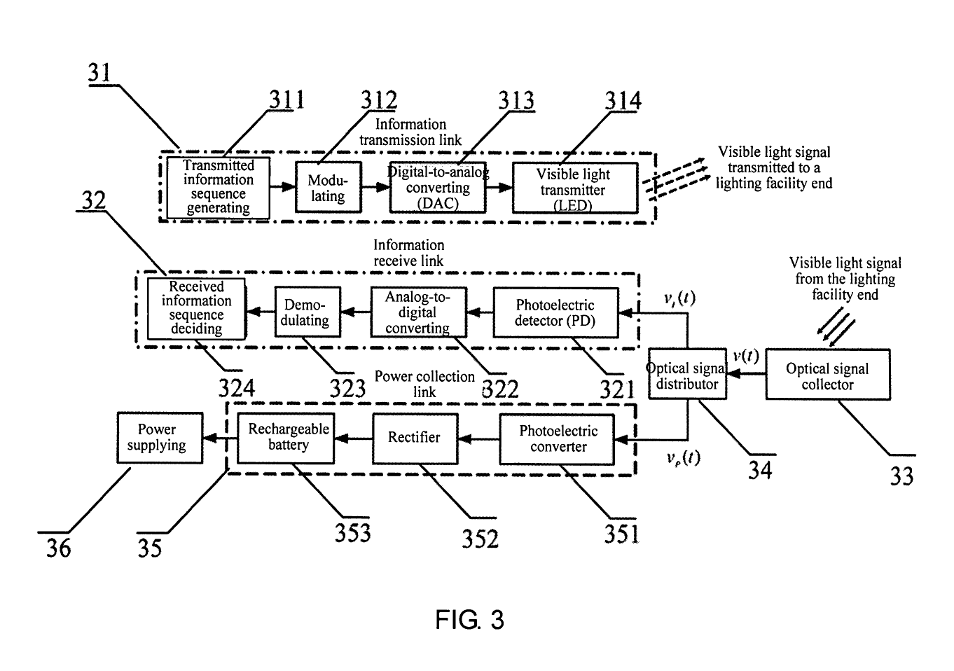

FIG. 2 and FIG. 3 are two kinds of visible light power-carrying communication systems of a mobile user end. Compared with the structure as shown in FIG. 1, a signal distribution module is added in the visible light power-carrying communication system of the mobile user end, thus a signal is divided into two parts, where one part enters into an information receive link for acquiring transmitted information, and the other part enters into a power collection link for collecting power of a received visible light signal.

Specifically, the visible light power-carrying communication system of the mobile user end according to the present invention includes five main function modules: an information transmission link, a signal collection module, a signal distribution module, an information receive module and a power collection link. The signal collection module is connected to the signal distribution module, and the signal distribution module is then connected to the information receive link and the power collection link respectively. In the signal distribution module, implementations thereof will be different according to different distributed signals.

Reference may be made to FIG. 2, the visible light power-carrying communication system of the mobile user end based on electrical signal distribution according to the present invention at least includes an information transmission link 21, a photoelectric detector 23, an electrical signal distributor 24, an information receive link 22, a power collection link 25 and a power supplying module 26.

The information transmission link 21 at least includes modules such as a transmitted information sequence generating module 211, a modulating module 212, a digital-to-analog converting module (DAC) 213 and a visible light transmitter 214 connected sequentially. The photoelectric detector 23 receives a visible light signal from the lighting facility end and converts a same into an electrical signal. The electrical signal distributor 24 divides it into two signals according to a certain rule, one of which is supplied to the information receive link 22 and the other is supplied to the power collection link 25. The information receive link 22 at least includes an analog-to-digital converting module (ADC) 221, a demodulating module 222 and a received information sequence deciding module 223 and so on which are connected sequentially. The power collection link 25 at least includes modules such as a rectifier 251 and a rechargeable battery 252. The rechargeable battery 252 supplies electric energy to all modules within the present apparatus via the power supplying module 26. The rectifier 251 is configured to convert the electrical signal into a current suitable for charging the rechargeable battery.

Specifically, a signal transmission flow of the visible light power-carrying communication system of the mobile user end based on electrical signal distribution is: the transmitted information sequence generating module 211 generates an information sequence to be transmitted, the modulating module 212 performs non-constant envelope modulation on the information sequence, and then the digital-to-analog converter module 213 converts it into an analog electrical signal, where the analog electrical signal drives the visible light transmitter 214 to emit a visible light signal with loaded information; a signal receive flow is: the photoelectric detector 23 receives a visible light signal from the lighting facility end and converts a same into an electrical signal, the electrical signal distributor 24 divides it into two signals according to a certain rule, one of which is supplied to the information receive link 22 and the other is supplied to the power collection link 25. In the information receive link 22, the electrical signal is converted into a digital signal via the analog-to-digital converter 221, which is then processed, such as being demodulated, by the demodulating module 222 in a digital domain. And finally the received information sequence deciding module 223 decides a received information sequence. In the power collection link 25, the rectifier 251 rectifies the electrical signal firstly, and then the rechargeable battery 252 is charged.

A distribution mode performed by the electrical signal distributor may be all implementable electrical signal distributing methods, which are specifically:

\textcircled{1} DC/AC distribution mode: a direct current portion of an electrical signal x(t) is distributed to the power collection link, that is, xₚ(t)=E[x(t)], xₚ(t) is an electrical signal distributed to the power collection link, E[] represents averaging; meanwhile an alternating current portion thereof is distributed to the information receive link, that is, x₁(t)=x(t)−E[x(t)], x₁(t) is an electrical signal distributed to the information receive link.

\textcircled{2} Complete power collecting distribution mode: If it is detected that there is no valid information transmitted on the information link, then all electrical signals are distributed to the power collection link. This mode is a special form of the DC/AC distribution mode.

\textcircled{3} Dynamic ratio distribution mode: The electrical signal distributor distributes information/power according to a dynamic ratio ρ(t) (the distribution ratio ρ(t) varies with time). An electrical signal distributed to the power collection link is: x_{P}(t)=ρ(t)·x(t); an electrical signal distributed to the information receive link is: x₁(t)=(1−ρ(t))·x(t). Where x_{P}(t) represents the electrical signal of the power collection link, x₁(t) represents the electrical signal of the information receive link. ρ(t) ∈[0,1] represents a dynamic distribution ratio of the electrical signal, which may be set according to an application scenario. If it is intended to guarantee acquisition of amount of information (smaller bit error ratio, higher signal-to-noise ratio), then increase power of the electrical signal distributed to the information receive link, i.e. reduce ρ; on the contrary, a purpose of collecting more power may be achieved by distributing more electrical signals to the power collection link, i.e. increase ρ.

\textcircled{4} Time division duplex distribution mode: If, in a visible light signal transmitted from the lighting facility end, information and power components use a time division duplex (Time Division Duplex, TDD) standard, then a corresponding standard may be used in the mobile user end to distribute electrical signals.

\textcircled{5} Frequency division duplex distribution mode: If, in a visible light signal transmitted from the lighting facility end, information and power components use a frequency division duplex (Frequency Division Duplex, FDD) standard, then a corresponding standard may be used in the mobile user end to distribute electrical signals.

An advantage of the DC/AC distribution mode lies in that: in the visible light power-carrying communication system proposed in the present invention, a visible light signal transmitted from the lighting facility end has a larger direct current component. This is because the visible light transmitter at the transmission end has a certain bias voltage or current, there is correspondingly a larger direct current component in a signal received by the mobile user end. Such direct current component causes great harm to information reception and decision in a receiver (whether in a visible light communication system or in a radio frequency wireless communication system). Use of the DC/AC distribution mode, in one aspect, may distribute a direct current component of a received signal to the power collection link, thereby obtaining effective charging energy; and in another aspect, also avoid direct current interference into the information receive link, thereby guaranteeing performance of information acquisition.

An advantage of the complete power collecting distribution mode lies in that: in a case where there is no information transmission in the visible light power-carrying communication system proposed in the present invention, the lighting facility end will still emit a visible light signal of certain intensity. At this time, a power stabilized visible light signal received by the mobile user end may be directly converted into a direct current electrical signal to supply charging energy to the rechargeable battery.

Certainly, electrical signal distribution modes of the visible light power-carrying communication system and the method proposed in the present invention are definitely not just limited to the above modes.

Reference may be made to FIG. 3, the visible light power-carrying communication system of the mobile user end based on optical signal distribution according to the present invention at least includes an information transmission link 31, an optical signal collector 33, an optical signal distributor 34, an information receive link 32, a power collection link 35, a power supplying module 36, etc.

The information transmission link 31 at least includes a transmitted information sequence generating module 311, a modulating module 312, a digital-to-analog converting module (DAC) 313 and a visible light transmitter 314 connected sequentially. The optical signal collector 33 is configured to collect a visible light signal from the lighting facility end. The optical signal distributor 34 divides, according to a certain rule, the collected visible light into two signals, one of which is supplied to the information receive link 32 and the other is supplied to the power collection link 35. The information receive link 32 at least includes a photoelectric detector 321, an analog-to-digital converting module 322, a demodulating module 323 and a received information sequence deciding module 324 connected sequentially. The power collection link 35 at least includes modules such as a photoelectric converter 351, a rectifier 352 and a rechargeable battery 353 connected sequentially. The rechargeable battery 353 supplies electric energy to all modules within the present system via the power supplying module.

A signal transmission flow of the visible light power-carrying communication system of the mobile user end based on optical signal distribution according to the present invention is: the transmitted information sequence generating module 311 generates an information sequence to be transmitted, the modulating module 312 performs non-constant envelope modulation on the information sequence, and then the digital-to-analog converting module 313 converts it into an analog electrical signal, where the analog electrical signal drives the visible light transmitter 314 to emit a visible light signal with loaded information. A signal receive flow is: the optical signal collector 33 collects a visible light signal from the lighting facility end, the optical signal distributor 34 divides, according to a certain rule, the visible light signal into two signals, one of which is supplied to the information receive link 32 and the other is supplied to the power collection link 35. In the information receive link 32, the photoelectric detector 321 converts the visible light signal into an electrical signal, the analog-to-digital converting module 322 converts the electrical signal into a digital signal, then the demodulating module 323 demodulates it in a digital domain, finally the received information sequence deciding module 324 decides a received information sequence, and finally digital information is obtained. In the power collection link 35, the photoelectric converter 351 converts the optical signal into an electrical signal firstly, then the rectifier 352 rectifies the electrical signal, and then the rechargeable battery 353 is charged.

The visible light power-carrying communication system of the mobile user end mainly provides wireless communication access services to a mobile user, which is of less electricity consumption. According to characteristics of the visible light, the visible light power-carrying communication system of the mobile user end is able to convert a portion of power of its received visible light into electric energy, and charge for the battery carried in itself, and meanwhile may also provide charging services to a mobile user equipment. In the power collection link, the photoelectric converter converts the optical signal into an electrical signal, and the electrical signal is an alternating current signal at this time. Subsequently, the rectifier is used to convert the alternating current electrical signal into a direct current signal, that is, capable of charging the rechargeable battery. Performance parameters of modules such as the optical signal collector, the photoelectric detector, the optical signal distributor and the rectifier are associated with the power finally obtained by the rechargeable battery. During practical use, performance parameters and selection of components such as the visible light transmitter, the optical signal collector, the photoelectric detector and the rectifier are generally obtained by practical experience in combination with a target application scenario.

In the present invention, a distribution mode performed by the optical signal distributor may be all implementable optical signal distributing methods, which are specifically:

\textcircled{1} Dynamic ratio distribution mode: The optical signal distributor performs information/power distribution on an optical signal ν(t) according to a dynamic ratio β(t) (the distribution ratio β(t) varies with time). An optical signal distributed to the power collection link is: ν_{P}(t)=β(t)·ν(t); an optical signal distributed to the information receive link is: ν₁(t)=(1−β(t))·ν(t). Where ν_{P}(t) represents the optical signal of the power collection link, ν₁(t) represents the optical signal of the information receive link. β(t) ∈[0,1] represents a dynamic distribution ratio of the optical signal, which may be set according to an actual application scenario. If it is intended to guarantee acquisition of amount of information (smaller bit error ratio, higher signal-to-noise ratio), then it needs to increase intensity of the optical signal distributed to the information link, i.e. reduce β; on the contrary, a purpose of collecting more power may be achieved by distributing more optical signals to the power link, i.e. increase β.

\textcircled{2} Complete power collecting distribution mode: If it is detected that there is no valid information transmitted on the information receive link, then all optical signals may be distributed to the power collection link. This mode is a special form of the dynamic ratio distribution mode.

\textcircled{3} Time division duplex distribution mode: If, in a visible light signal transmitted from the lighting facility end, information and power components use a time division duplex (Time Division Duplex, TDD) standard, then a corresponding standard may be used in the mobile user end to distribute optical signals.

\textcircled{4} Frequency division duplex distribution mode: If, in a visible light signal transmitted from the lighting facility end, information and power components use a frequency division duplex (Frequency Division Duplex, FDD) standard, then a corresponding standard may be used in the mobile user end to distribute optical signals.

An advantage of the complete power collecting distribution mode lies in that: in a case where there is no information transmission in the visible light power-carrying communication system proposed in the present invention, the lighting facility end will still emit a visible light signal of certain intensity. At this time, a power stabilized visible light signal received by the mobile user end is completely distributed to the power collection link, and is converted into a direct current electrical signal to charge the rechargeable battery.

Certainly, optical signal distribution modes of the visible light power-carrying communication system and the method proposed in the present invention are definitely not just limited to the above modes.

In the visible light power-carrying communication system according to the present invention, the visible light power-carrying communication system of the lighting facility end may perform informatization transformation on the existing lighting device directly, thereby providing wireless communication access services to a mobile user without affecting the lighting, and providing charging energy to a mobile user equipment. The visible light power-carrying communication system of the mobile user end may receive a visible light signal transmitted from the lighting facility end, and demodulate information therefrom and collect power to charge itself or a mobile device. The visible light power-carrying communication systems of both the lighting facility end and the mobile user end include a transmission module and a receive module, which perform information interaction via data downlink and uplink. With reference to the visible light power-carrying communication system described above, the visible light power-carrying communication method according to the present invention may transmit information and power simultaneously, specifically including steps of:

Data Downlink:

The visible light power-carrying communication system of the lighting facility end loads data information onto intensity of visible light, and provides wireless communication access services for a lighting area. The visible light power-carrying communication system of the mobile user end detects a light and dark variation in the visible light signal, and converts it into an electrical signal; the electrical signal is sampled by the analog-to-digital converter to obtain a digital signal, and is then subject to subsequent processing such as demodulation and information decision in a digital domain. At the time of receiving the information, a portion of light intensity of the visible light signal can also be converted into electric energy to charge the mobile user equipment.

Data Uplink:

The visible light power-carrying communication system of the mobile user end transmits a visible light signal with loaded information according to business demands of a mobile user. The visible light power-carrying communication system of the lighting facility end receives the visible light signal, and acquires the information from the mobile user end as born by the visible light signal after processing such as photoelectric detection, analog-to-digital conversion, demodulation, information decision.

Five embodiments of the visible light power-carrying communication system according to the present invention will be described in details hereunder.

### Embodiment 1

Step 1, data uplink (a mobile user end transmits a visible light signal, and a lighting facility end receives a same):

Steps where the mobile user end transmits a visible light signal:

Step 1-1, a transmitted information sequence generating module generates an information sequence to be transmitted;

Step 1-2, a modulating module performs non-constant envelope modulation on the information sequence;

Step 1-3, the modulated signal is converted into an analog electrical signal via a digital-to-analog converting module;

Step 1-4, the described analog electrical signal drives a visible light transmitter to emit a visible light signal with varying light intensity.

Steps where the lighting facility end receives a visible light signal:

Step 1-5, a photoelectric detector detects a visible light signal, and converts it into an electrical signal;

Step 1-6, the electrical signal is converted into a digital signal via an analog-to-digital converting module;

Step 1-7, a demodulating module processes the digital signal in a digital domain, such as demodulates the digital signal;

Step 1-8, a received information sequence deciding module decides information bits carried by the visible light signal.

Step 2, data downlink (the lighting facility end transmits a visible light signal, and the mobile user end receives a same):

The visible light power-carrying communication system of the lighting facility end and the visible light power-carrying communication system of the mobile user end based on electrical signal distribution complete transmission of downlink data.

Steps where the lighting facility end transmits a visible light signal:

Step 2-1, a transmitted information sequence generating module generates an information sequence to be transmitted;

Step 2-2, a modulating module performs non-constant envelope modulation on the information sequence;

Step 2-3, the modulated signal is converted into an analog electrical signal via a digital-to-analog converting module;

Step 2-4, the described analog electrical signal drives a visible light transmitter to emit a visible light signal with varying light intensity.

Steps where the mobile user end based on electrical signal distribution receives a visible light signal:

Step 2-5, a photoelectric detector detects a visible light signal, and converts it into an electrical signal x(t);

Step 2-6, an electrical signal distributor is used to divide the electrical signal into two parts: x₁(t) is distributed to an information receive link, and x_{P}(t) is distributed to a power collection link; the distribution mode employed is a DC/AC distribution mode: a direct current portion of the electrical signal x(t) is distributed to the power collection link, that is, x_{ρ}(t)=E[x(t)]; and meanwhile an alternating current portion is distributed to the information receive link, that is, x₁(t)=x(t)−E[x(t)];

Step 2-7, the information receive link and the power collection link are in parallel and independent of each other, which may process electrical signals distributed thereto respectively:

Step 2-7.1, in the information receive link, the electrical signal x₁(t) is subject to analog-to-digital conversion firstly, and then is subject to digital signal processing such as demodulation and decision, and information bits carried by the visible light signal are obtained finally.

Step 2-7.2, in the power collection link, a rectifier reshapes the electrical signal x_{ρ}(t) and filters its high frequency component to enable the signal to be suitable for charging a rechargeable battery; the power collected by the power collection link is: P=∫ƒ(E[x(t)])dt, where ƒ(·) is a response function of the rectifier.

Hereto, the receive end completes simultaneous reception of information and power in the visible light signal.

It should be noted that, in the above method, the two steps, i.e. the data uplink and the data downlink, are not performed sequentially, but are performed selectively according to an actual need.

### Embodiment 2

Step 1 (including sub-steps 1-1˜1-8) and Step 2 (including sub-steps 2-1˜2-5) are the same as those in Embodiment 1.

Step 2-6, the electrical signal distributor is used to divide the electrical signal into two parts: x₁(t) is distributed to an information receive link, and x_{P}(t) is distributed to a power collection link; the distribution mode employed is a complete power collecting distribution mode (that is, a case where there is no valid information transmitted on the information link): the entire electrical signal x(t) is distributed to the power collection link, that is, x_{ρ}(t)=x(t); at this time, there is no signal distribution in the information receive link;

Step 2-7, in the power collection link, a rectifier reshapes the electrical signal x_{ρ}(t) to enable the signal to be suitable for charging a rechargeable battery. The power collected by the power collection link is: P=∫ƒ(x(t))dt, where ƒ(·) is a response function of the rectifier.

It should be noted that, in the above method, the two steps, i.e. the data uplink and the data downlink, are not performed sequentially, but are performed selectively according to an actual need.

### Embodiment 3

Step 1 (including sub-steps 1-1˜1-8) and Step 2 (including sub-steps 2-1˜2-5) are the same as those in Embodiment 1.

Step 2-6, the electrical signal distributor is used to divide the electrical signal into two parts: x₁(t) is distributed to an information receive link, and x_{P}(t) is distributed to a power collection link; the distribution mode employed is a dynamic ratio distribution mode (its distribution ratio ρ(t) varies with time): an electrical signal distributed to the power collection link is: x_{P}(t)=ρ(t)·x(t); an electrical signal distributed to the information receive link is: x₁(t)=(1−ρ(t))·x(t);

Step 2-7, the information receive link and the power collection link are in parallel and independent of each other, which may process electrical signals distributed thereto respectively:

Step 2-7.1, in the information receive link, the electrical signal x₁(t) is subject to analog-to-digital conversion firstly, and then is subject to digital signal processing such as demodulation and decision, and information bits carried by the visible light signal are obtained finally.

Step 2-7.2, in the power link, a rectifier reshapes the electrical signal x_{ρ}(t) and filters its high frequency component to enable the signal to be suitable for charging a rechargeable battery. The power collected by the power collection link is: P=∫ƒ(ρ(t)·x(t))dt, where ƒ(·) is a response function of the rectifier.

Hereto, the receive end completes simultaneous reception of information and power in the visible light signal.

It should be noted that, in the above method, the two steps, i.e. the data uplink and the data downlink, are not performed sequentially, but are performed selectively according to an actual need.

### Embodiment 4

Step 1 (including sub-steps 1-1˜1-8) and Step 2 (including sub-steps 2-1˜2-4) are the same as those in Embodiment 1.

Steps where the mobile user end based on optical signal distribution receives a visible light signal:

Step 2-5, an optical signal collector collects a visible light signal ν(t);

Step 2-6, an optical signal distributor divides the optical signal into two parts: ν₁(t) is distributed to an information receive link, and ν_{P}(t) is distributed to a power collection link; the distribution mode employed is a dynamic ratio distribution mode (its distribution ratio β(t) varies with time): an optical signal distributed to the power collection link is: ν_{P}(t)=β(t)·ν(t); an optical signal distributed to the information receive link is: ν₁(t)=(1−β(t))·ν(t);

Step 2-7, the information receive link and the power collection link are independent of each other, which may process optical signals distributed thereto in parallel, respectively:

Step 2-7.1, in the information receive link, a photoelectric detector detects an intensity variation in the visible light signal, and converts it into an electrical signal, the electrical signal is subject to analog-to-digital conversion to become a digital signal, which is then subject to digital signal processing such as demodulation and decision, and information bits carried by the visible light signal are obtained finally.

Step 2-7.2, in the power collection link, a photoelectric converter is used firstly to convert the optical signal into an electrical signal, then a rectifier is used to reshape the electrical signal, and finally a rechargeable battery is charged. The power collected by the power collection link is: P=∫ƒ(η·β(t)·ν(t))dt, where η is conversion efficiency of the photoelectric converter, and ƒ(·) is a response function of the rectifier.

Hereto, the receive end completes simultaneous reception of information and power in the visible light signal.

It should be noted that, in the above method, the two steps, i.e. the data uplink and the data downlink, are not performed sequentially, but are performed selectively according to an actual need.

### Embodiment 5

Step 1 (including sub-steps 1-1˜1-8) and Step 2 (including sub-steps 2-1˜2-5) are the same as those in Embodiment 4.

Step 2-6, an optical signal distributor divides the optical signal into two parts: ν₁(t) is distributed to an information receive link, and ν_{P}(t) is distributed to a power collection link; the distribution mode employed is a complete power collecting distribution mode (that is, there is no valid information transmitted on the information link): the entire optical signal ν(t) is distributed to the power collection link: ν_{P}(t)=ν(t); at this time, there is no signal distribution in the information receive link.

Step 2-7, in the power collection link, a photoelectric converter is used firstly to convert the optical signal into an electrical signal, then a rectifier is used to reshape the electrical signal, and finally a rechargeable battery is charged. The power collected by the power collection link is: P=∫ ƒ(η·ν(t))dt, where η is conversion efficiency of the photoelectric converter, and ƒ(·) is a response function of the rectifier.

It should be noted that, in the above method, the two steps, i.e. the data uplink and the data downlink, are not performed sequentially, but are performed selectively according to an actual need.

In conclusion, the visible light power-carrying communication system and the method according to the present invention combine a visible light communication system with wireless power transmission technologies, and add a power link to collect power carried by a visible light signal with regard to characteristics of the visible light communication system, forming a complete set of visible light power-carrying communication systems; the visible light power-carrying communication system and the method according to the present invention combine advantages of the visible light communication system, such as ultra-wide bandwidth, free frequency band, low power consumption of a transceiver, and solve the problem that a mobile terminal depends on a power line by means of the wireless power transmission technologies, thereby realizing simultaneous wireless transmission of information and power realistically. Thus, the present invention effectively overcomes several disadvantages in the prior art, and possesses high industrial utilization value.

The foregoing embodiments are intended for describing principles and effects of the present invention illustratively, rather than limiting the present invention. Any person familiar with this technology can make modifications or changes to the above embodiments without departing from the spirit and scope of the present invention. Thus, all equivalent modifications or changes made by persons of ordinary skill in the art without departing from the spirit and technical thoughts disclosed in the present invention are still included in claims of the present invention

What is claimed is:

1. A visible light power-carrying communication system of a mobile user end, wherein: the visible light power-carrying communication system of the mobile user end at least comprises:
an information transmission link, configured to transmit a visible light signal to a lighting facility end;
a signal collection module, configured to receive a visible light signal from the lighting facility end;
a signal distribution module, configured to divide, according to a certain rule, a signal output by the signal collection module into two signals, one of which is supplied to an information receive link and the other is supplied to a power collection link;
the information receive link, configured to receive information carried in the visible light signal; and
the power collection link, configured to collect power carried in the visible light signal;
wherein the signal collection module is connected to the signal distribution module, and the signal distribution module is then connected to the information receive link and the power collection link respectively.

2. The visible light power-carrying communication system of the mobile user end according to claim 1, wherein: the information transmission link at least comprises a transmitted information sequence generating module, a modulating module, a digital-to-analog converting module and a visible light transmitter connected sequentially.

3. The visible light power-carrying communication system of the mobile user end according to claim 1, wherein: in the visible light power-carrying communication system of the mobile user end based on electrical signal distribution, the signal collection module comprises a photoelectric detector which is configured to receive a visible light signal from the lighting facility end and convert the visible light signal into an electrical signal; the signal distribution module comprises an electrical signal distributor which is configured to divide according to a certain rule the electrical signal output by the photoelectric detector into two signals, one of which is supplied to the information receive link and the other is supplied to the power collection link.

4. The visible light power-carrying communication system of the mobile user end according to claim 3, wherein: the information receive link at least comprises an analog-to-digital converting module, a demodulating module and a received information sequence deciding module connected sequentially.

5. The visible light power-carrying communication system of the mobile user end according to claim 3, wherein: the power collection link at least comprises a rectifier and a rechargeable battery, wherein the rechargeable battery is connected to a power supplying module, and is configured to supply electric energy to all modules within the visible light power-carrying communication system.

6. The visible light power-carrying communication system of the mobile user end according to claim 1, wherein: in the visible light power-carrying communication system of the mobile user end based on optical signal distribution, the signal collection module comprises an optical signal collector which is configured to collect a visible light signal from the lighting facility end; the signal distribution module comprises an optical signal distributor which is configured to divide according to a certain rule an optical signal output by the optical signal collector into two signals, one of which is supplied to the information receive link and the other is supplied to the power collection link.

7. The visible light power-carrying communication system of the mobile user end according to claim 6, wherein: the information receive link at least comprises a photoelectric detector, an analog-to-digital converting module, a demodulating module and a received information sequence deciding module connected sequentially.

8. The visible light power-carrying communication system of the mobile user end according to claim 6, wherein: the power collection link at least comprises a photoelectric converter, a rectifier and a rechargeable battery connected sequentially, wherein the rechargeable battery is connected to a power supplying module, and is configured to supply electric energy to all modules within the visible light power-carrying communication system.

9. A visible light power-carrying communication system, comprising: a visible light power-carrying communication system of a lighting facility end and a visible light power-carrying communication system of a mobile user end according to claim 1,
wherein the visible light power-carrying communication system of the lighting facility end comprises an information transmission link and an information receive link, the information transmission link comprises a transmitted information sequence generating module, a modulating module, a digital-to-analog converting module and a visible light transmitter connected sequentially; the information receive link comprises a photoelectric detector, an analog-to-digital converting module, a demodulating module and a received information sequence deciding module connected sequentially.

10. A communication method of a visible light power-carrying communication system according to claim 9, comprising steps of:
step 1, data uplink:
steps wherein a mobile user end uses the following steps to transmit a visible light signal:
step 1-1, generating an information sequence to be transmitted;
step 1-2, modulating the information sequence;
step 1-3, performing digital-to-analog conversion on a modulated signal to obtain an analog electrical signal;
step 1-4, driving a visible light transmitter with the analog electrical signal described in the step 1-3 to emit a visible light signal with varying light intensity;
steps wherein a lighting facility end uses the following steps to receive a visible light signal:
step 1-5, detecting, by a photoelectric detector, a visible light signal, and converting the visible light signal into an electrical signal;
step 1-6, performing analog-to-digital conversion on the electrical signal to obtain a digital signal;
step 1-7, demodulating the digital signal in a digital domain;
step 1-8, deciding information bits carried by the visible light signal;
step 2, data downlink:
steps wherein the lighting facility end uses the following steps to transmit a visible light signal:
step 2-1, generating an information sequence to be transmitted;
step 2-2, modulating the information sequence;
step 2-3, performing digital-to-analog conversion on a modulated signal to obtain an analog electrical signal;
step 2-4, driving a visible light transmitter with the analog electrical signal described in the step 2-3 to emit a visible light signal with varying light intensity;
steps wherein the mobile user end uses the following steps to receive a visible light signal:
step 2-5, receiving, by a signal collection module, a visible light signal from the step 2-4;
step 2-6, dividing, by a signal distribution module, a signal output by the signal collection module into two signals according to a certain rule, one of which is distributed to an information receive link and the other is distributed to a power collection link;
step 2-7, processing, by the information receive link, the distributed signal, and finally obtaining information bits carried by the visible light signal; processing, by the power collection link, the distributed signal, and finally collecting electric energy in the visible light signal into a rechargeable battery.
